(19) United States
(12) Patent Application Publication
(10) Pub. No.: US 2012/0152129 A1
(43) Pub. Date: Jun. 21, 2012

(54) FOOD ROASTING DEVICE

(76) Inventor: René Mauricio NUÑEZ SUÁREZ, San Salvador (SV)

(21) Appl. No.: 13/336,066

(22) Filed: Dec. 23, 2011

Related U.S. Application Data
(63) Continuation of application No. PCT/SV2009/000002, filed on Jun. 23, 2009.

(51) Int. Cl. A47J 37/07

(52) U.S. Cl. 99/447

(57) ABSTRACT

Food roasting device comprising three detachable pieces (1, 6 and 9) mounted one on top of the other. The first piece (1) is the one with a free top side and is the support for the food to roast; the third piece (9) is the one with its bottom side in contact with an external heating source; the second piece (6) is the one in the middle of both pieces, the first one (1) and the third one (9). These three pieces (1, 6 and 9) are flat metal sheets, thin in relation to their size. The first (1) and the third (9) can take any shape provided that they are identical; the second piece (6) is circular and its diameter is smaller than the first piece (1) and the third piece (9).

This application is a continuation of international application PCT/SV2009/000002, filed Jun. 23, 2009, which is hereby incorporated by reference in its entirety.

### OBJECT OF THE INVENTION

According to this descriptive memory, the primary object of this invention is to provide a food roasting device consisting of three main detachable pieces mounted one on top of the other. Likewise, it is also its object to provide a food roasting device that can spread the heat homogeneously all through the surface on which the food will be roasted in order to have an ideal heat transmission and so that all the food is equally roasted. Moreover, there is a considerable energy saving and the pollutant emissions are minimized.

### TECHNICAL FIELD OF THE INVENTION

This invention is in the group of cooking tools. It has a general application in industrial kitchens and home kitchens.

It is highlighted that this device is adaptable to all kinds of cookers and rings of both home and outdoor cooking plates.

Among the practical and concrete applications of this invention we can mention that this invention was conceived to be used with the heat generator and transmitter described in application PCT/SV2008/000003 and with the device described in U.S. Pat. No. 6,651,645 B1 to cook pancaked and tortillas.

### DESCRIPTION OF THE PRIOR ART

Nowadays there are a lot of food roasting devices, such as hotplates and pans, consisting of a flat metal sheet, thin in relation to their size. Nevertheless, the existence of other devices, hotplates or pans, to roast food consisting of three main detachable pieces mounted one on top of the other is not known.

### SUMMARY OF THE INVENTION

This invention's primary object is to provide a food roasting device consisting of three main pieces mounted one on top of the other, in such a way that three different plates separated by air spaces can be seen in a sectional view. Furthermore, these three main pieces are detachable. The first one is in direct contact with the food to be roasted. The third piece is the one with its bottom side in contact with an external heating source. The second piece is the one in the middle of the first and the third piece.

Thus, the first piece is a flat metal sheet, thin in relation to its size, which can take any shape. Likewise, the top side of the first piece has, surrounding its perimeter, a prominent edge whose angle of inclination in relation to the flat metal sheet is acute and whose height is higher than the thickness of the flat metal sheet.

The second piece is also a flat metal sheet, thin in relation to its size, whose shape is preferably circular, being its diameter smaller than the first piece size.

And the third piece is also a flat metal sheet, thin in relation to its size, which can take any shape, provided that this shape is identical to the shape of the first piece.

Moreover, the first piece has on its bottom side some fixing elements, which can be screws, pin, bolts or the like, with their respective adjusting nuts and their spacer nuts, which are arranged at a distance of the centre of the first piece larger than the radius of the second one, in such a way that the first piece can be fixed to the third one leaving a fixed and determined space defined by the spacer nuts. The second sheet will be introduced in that space. The height of the spacer nuts will depend on the size of the device. Moreover, the first piece has on its bottom side some other fixing elements, which can be screws, pin or bolts with their respective adjusting nuts, which are arranged at a distance of the centre of the first piece that is smaller than the radius of the second one, so the first piece can be fixed to the second one leaving a determined space that is defined by the height of some protuberances on the second piece.

The protuberances on the second piece are arranged on its top side, preferably radially distributed, although a random distribution is also admitted. Those protuberances are preferably made by hitting the bottom side of the second piece, so the slots on the bottom side are converted into protuberances or bulges on the top side of the second piece. Those protuberances could also be made by welding or attaching small pieces of metal directly to the top side of the second piece. The preferable height of the protuberances would vary depending on the size of the food roasting device, although the size will always be similar to the thickness of the metal sheet of the pieces.

Furthermore, there are holes between the protuberances of the second piece, preferentially, radially distributed, although a random distribution is also admitted. Fixing elements such as pins, bolts, screws or the like, are introduced through the holes that the first piece has in its bottom side in order to fix the first piece to the second one.

The third piece has an its top side, surrounding its perimeter, a prominent edge whose angle of inclination in relation to the flat metal sheet is also acute, although with an opening that is wider than the angle of the prominent edge of the top side of the first piece, and its height is bigger than the thickness of the flat metal sheet.

Furthermore, the third piece has inside a main circular hole with a slightly larger diameter than, or similar to, the diameter of the second piece in order to use the heat from the heating source to roast the food. The third piece also has holes coincident with the fixing elements of the first piece and that will allow these elements to be introduced so that they can be fixed by an adjusting nut.

Lastly, the third piece has handles to remove the device from the fire.

It is important to take into account that in all the cases in which the fixing elements that are put through the mentioned holes, the diameter of the hole must be slightly larger than the diameter of the fixing element. This is so because the three pieces are exposed to different temperatures and, therefore, its dilatation would be different too, so since the diameter of the hole is slightly larger than the diameter of the fixing element this will allow two different kinds of dilatation in the three pieces avoiding them to bow. For this reason, it is also crucial to put together the three pieces by fixing element such as pins, bolts, screws or the like, and not by welding, clinching or sticking them together.

Thus, the device described in this invention allows the heat to go through the main hole of the third piece and reach the second piece, but not the first one, which is where the food is placed on. This method distributes the heat uniformly all over the surface where the food is placed on, i.e., the top side of the first piece. Furthermore, the prominent edge of the third piece keeps the heat in the space between the first and the third pieces, producing the “oven effect”. Likewise, the different angle of inclination, which is wider for the prominent edge of the third piece, allows the heat that had come in through the main hole of the third piece to be led upwards, heating the prominent edge of the first piece whose angle of inclination is smaller, so the heat can also reach the food that is in contact with this prominent edge of the first piece.

### BRIEF DESCRIPTION OF THE DRAWINGS

The present invention will be fully understood on the basis of the brief description below and the supplementary drawings that are presented as examples only, and thus they are not restrictive in the present invention and where:

FIG. 1 shows a plan view of the food roasting device object of the present invention;

FIG. 2 shows a sectional view of the cut along the A-B line at the previous figure;

FIG. 3 shows a bottom view of the food roasting device object of the present invention;

FIG. 4 shows a sectional view of the cut along the A-B line, according to a preferred embodiment of the present invention, whose plan view is still the same as that of FIG. 1;

FIG. 5 shows a bottom view of the food roasting device, according to a preferred embodiment of the present invention.

### REFERENCES

1: first piece;

2: prominent edge of the first piece;

3: fixing elements from the first to the third piece;

4: adjusting nuts;

5: spacer nuts;

6: second piece;

7: protuberances of the second piece;

8: holes of the second piece;

8: fixing elements from the first to the second piece;

9: third piece;

10: prominent edge of the third piece;

11: main hole of the third piece;

12: holes of the third piece;

13: supports of the first piece;

14: slots of the third piece;

15: handles;

α: angle between the prominent edge of the first piece and the horizontal;

β: angle between the prominent edge of the third piece and the horizontal;

### DETAILED DESCRIPTION OF THE PREFERRED EMBODIMENTS

In order to have a better understanding of the purpose and functionality of this patent, and without it being construed as restrictive solutions, this is a description of an embodiment of the invention based on the figures given above.

As it has already been stated, this invention's primary object is to present a food roasting device consisting of three main pieces (1, 6, 9) mounted one on top of the other, in such a way that three different plates separated by air spaces can be seen in a sectional view. Furthermore, these three main pieces (1, 6, 9) are detachable. The first piece (1) is in direct contact with the food to be roasted. The third piece (9) is that one with its bottom side in contact with the heating source. The second piece (6) is the one in the middle of the first piece (1) and the third piece (9).

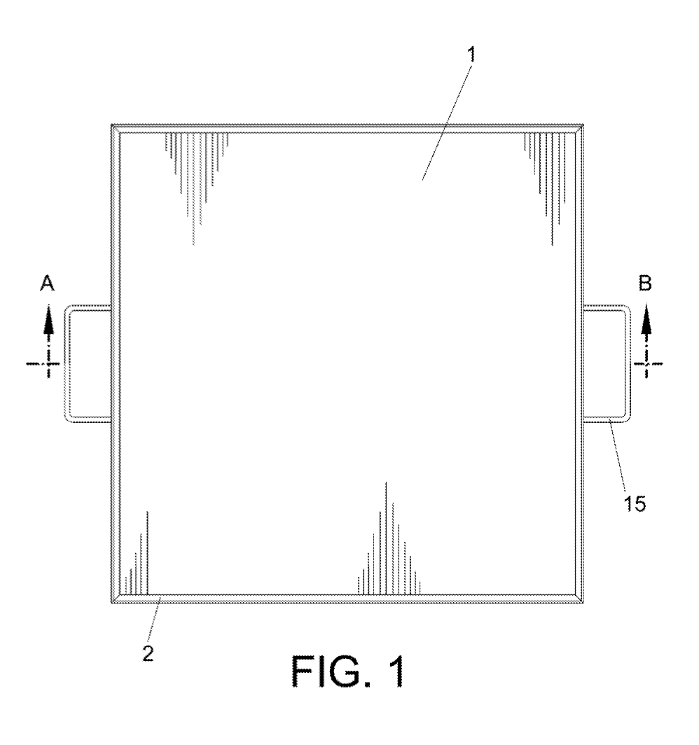

Thus, FIG. 1 shows how the plan view of a device would be as described by the present invention. That is, in a plan view, one can see the top side of the first part (1) and the handles (15) that are embedded in the third piece (9), since the second piece (6) and the third piece (9) are hidden under the first part (1) in this view. Also, in FIG. 1, the first square part (1) has been represented, being this the preferred shape, although as it as been previously stated, both the first piece (1) and the third piece (9) can take any shape.

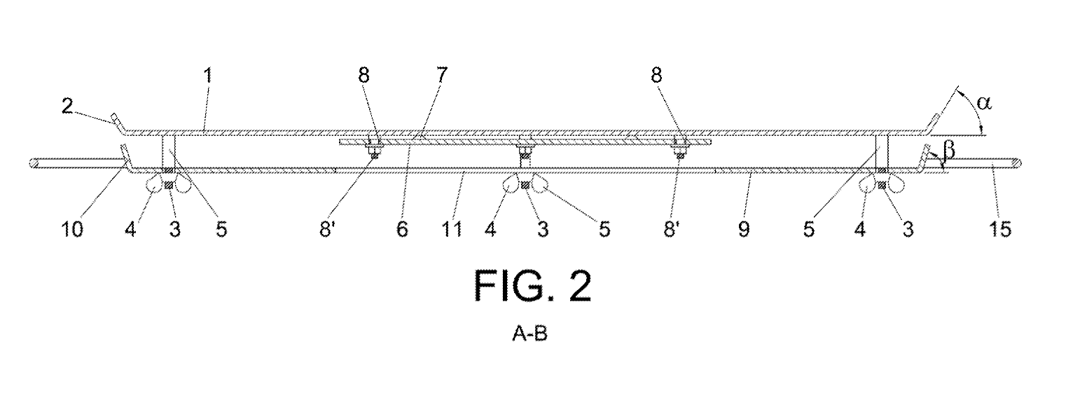

FIG. 2 shows that the first piece (1) is a flat metal sheet, which is thin in relation to its size. Likewise, the top side of the first piece has, surrounding its perimeter, a prominent edge (2) with an angle (α) of inclination in relation to the flat metal sheet is acute (45° preferably) and with a height larger than the thickness of the flat metal sheet (3 to 5 times thicker).

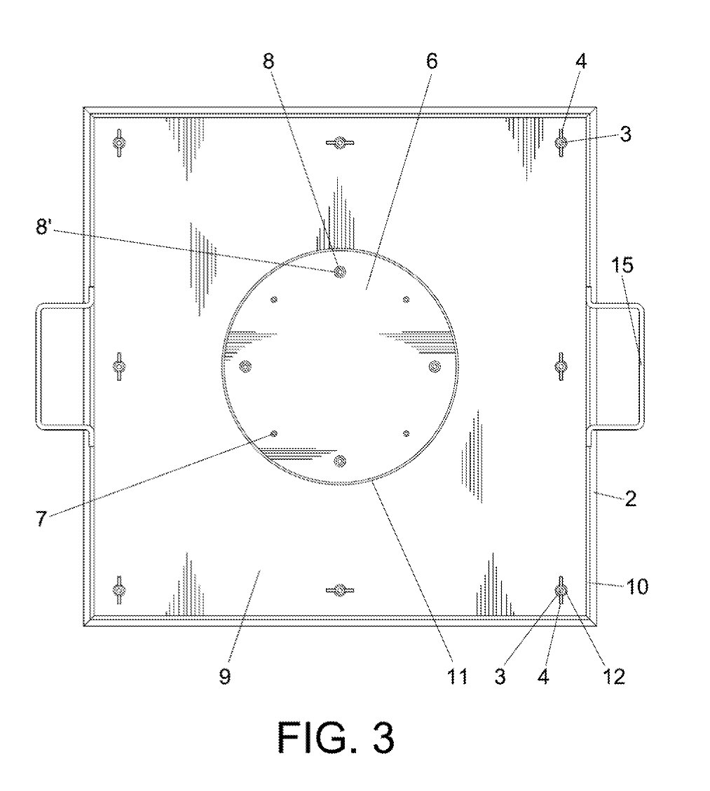

FIG. 2 also shows that the second piece (6) is a flat metal sheet, thin in relation to its size and preferably circular (this shape is not seen in FIG. 2 since it is a sectional view, but it can be seen in FIG. 3), being its diameter smaller than the first part (1).

FIG. 2 also shows that the third piece (9) is also a flat metal sheet, thin in relation to its size, which can take any shape, provided that this shape is identical to the shape of the first piece (1). Thus, in this preferred embodiment, the third piece (9) is also a square, like the first piece (1).

Furthermore, the first piece (1) has on its bottom side some fixing elements (3) that may be pins, bolts, screws or similar with their respective adjusting nut (4) (for example, a wing nut or something else that serves similar functions) and spacer nuts (5), which are arranged at a distance of the centre of the first piece (1) that is larger than the radius of the second one (6), tending towards the area where the prominent edge starts (2), so that the first piece (1) can be fixed to the third one (9) leaving a fixed and determined space that is defined by the spacer nuts (5), space where the second piece (6) will be introduced. The height of the spacer nuts (5) will depend on the size of the device. The spacer nuts will preferably be 6 to 7 times thicker than the metal sheet.

Likewise, the second piece (6) has some protuberances (7) on its top side, preferably radially distributed, although a random distribution is also admitted. Those protuberances (7) are preferably made by hitting the bottom side of the second piece (6), so the slots on the bottom side are converted into protuberances (7) or bulges on the top side of the second piece (6). Those protuberances (7) could also be made by welding or attaching small pieces of metal directly to the top side of the second piece. The preferable height of the protuberances (7) would vary depending on the size of the food roasting device, although the size will always be similar to the thickness of the metal sheets of the pieces (1, 6 and 9).

Furthermore, there are holes (8) between the protuberances (7) of the second piece (6), preferentially distributed radially, although a random distribution is also admitted. Fixing elements (8′) such as pins, bolts or screws or similar are introduced through the holes (8) that are on the bottom side of the first piece (1), in such a way that the second piece (6) is fixed to the first piece (1). As FIG. 3 shows, the food roasting device has preferably another piece (6) with four protuberances (7) and four holes (8) through which the four fixing elements (8′) are introduced.

Moreover, FIG. 2 shows that the third piece (9) has on its top side, surrounding its perimeter, a prominent edge (10) with an angle of inclination (β) in relation to the flat metal sheet also acute, although wider than the angle (α) with the prominent edge (2) on the top side of the first piece (1). According to the preferred embodiments, the angle of inclination (β) between the prominent edge (10) of the third piece (9) and in relation to the flat metal piece is 75°. Furthermore, the height of the prominent edge (10) of the third piece (9) is higher than the thickness of the flat metal sheet, preferably 5 to 6 times higher.

FIG. 3 shows that the third piece (9) has inside a main circular hole (11) with a slightly larger diameter than, or the same as, the second piece (6) in order to allow the heat from the heating source to come in and be used to roast the food. It has holes (12) that coincide with the fixing elements (3) of the first piece (1) to allow the fixing elements (3) to be introduced and to be fixed afterwards by an adjusting nut (4).

Lastly, FIG. 3 shows that the third piece (9) has handles (15) to remove the device from the fire. FIGS. 1 and 3 show two handles (15), one on each side, taking only one pair of opposite sides of the square shape, although the handles (15) could be distributed in a different way in relation to the size of the device, for example, with two or more handles (15) on each opposite side.

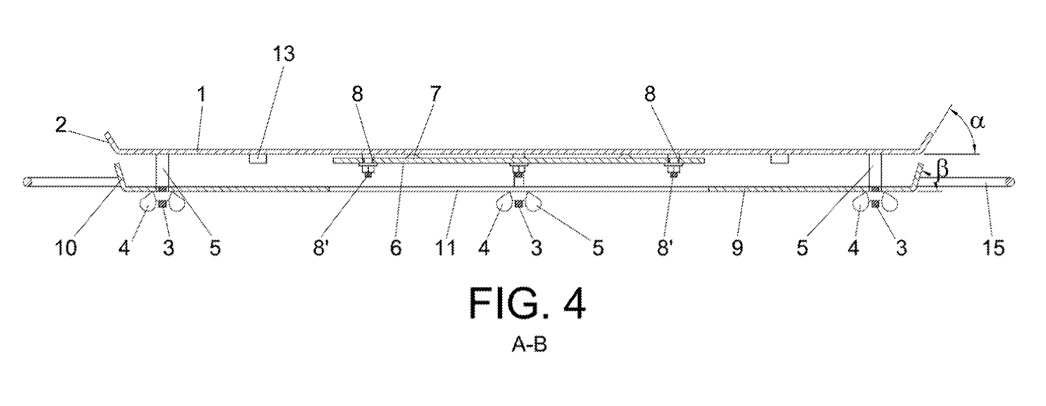

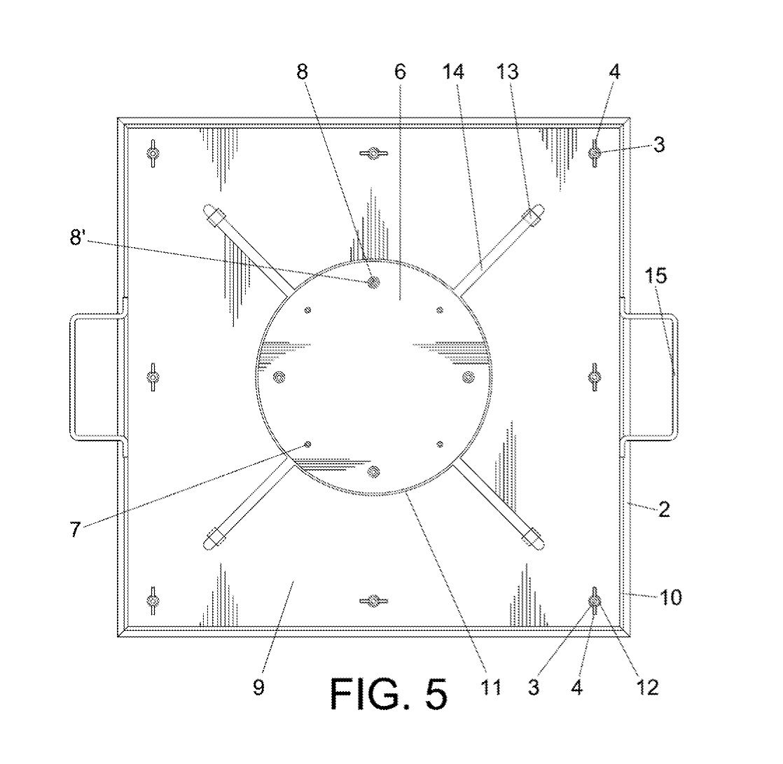

According to the preferred embodiments, FIGS. 4 and 5 also show that the first piece (1) has supports (13) radially distributed at a distance from the centre of the piece that is larger than the radius of the second piece (6), said distances coincide with some slots (14) on the third piece (9), radially distributed and equidistant, so that the supports (13) can fit into the slots (14). FIG. 5 show four supports (13) on the first piece (1) and four slots (14) on the third piece (9), although this number of slots and supports may vary.

It is important to take into account that in all the cases in which the fixing elements that go through the holes have been mentioned, the diameter of the hole (8, 12) must be slightly larger than the diameter of the fixing element (3, 8′). This is so because the three pieces (1, 6 and 9) are exposed to different temperatures and, therefore, its dilatation would be different too, so since the diameter of the hole (8, 12) is slightly larger than the diameter of the fixing element (3, 8′) this will allow two different kinds of dilatation in the three pieces (1, 6 and 9) avoiding them to bow. For this reason, it is also crucial to put together the three pieces (1, 6 and 9) by fixing element such as pins, bolts or screws, and not by welding, clinching or sticking them together.

1. Food roasting device comprising three detachable pieces (1, 6 and 9) mounted one on top of the other, so that:
the first piece (1) is that one with a free top side and the support for the food to roast,
the third piece (9) is that one with a bottom side in contact with an external heating source, and
the second piece (6) is the one in the middle of the first piece (1) and the third piece (9).
the three pieces (1, 6 and 9) are flat metal sheets, thin in relation to their size, so that:
the first piece (1) takes any shape,
the third piece (9) takes any shape, provided that it is identical to the first piece (1), and
the second piece (6) is circular with a diameter smaller than the first piece (1) and the third piece (9).

2. Food roasting device, according to claim 1, wherein the first piece (1) has on its top face, surrounding its perimeter, a prominent edge (2), whose angle of inclination (α) in relation to the horizontal is acute.

3. Food roasting device, according to claim 2, wherein the third piece (9) has on its top face, surrounding its perimeter, a prominent edge (10), with an acute angle of inclination (β) in relation to the horizontal, but always wider than the angle of inclination (α) of the prominent edge (2) of the first piece (1).

4. Food roasting device, according to claim 3, wherein the first piece (1) has on its bottom face some fixing elements (3) with their respective adjusting nut (4) and spacer nuts (5) in such a way that the fixing elements (3) are arranged at a distance from the centre of the first part (1) greater than the radius of the second piece (6); the fixing elements (3) fit in the spacer nuts (5) so as to fix the first piece (1) to the third piece (9) when they are introduced through the holes (12) of the third piece (9) and adjusted by the adjusting nuts (4).

5. Food roasting device, according to claim 4, wherein the first piece (1) also has supports (13) and the third piece (9) has slots (14), such that the distribution of slots (14) and supports (13) must coincide.

6. Food roasting device, according to claim 2, wherein the angle of inclination (α) of the prominent edge (2) of the first piece (1) in relation to the horizontal is 45°.

7. Food roasting device, according to claim 3, wherein the angle of inclination (α) of the prominent edge (2) of the first piece (1) in relation to the horizontal is 45°.

8. Food roasting device, according to claim 4, wherein the angle of inclination (β) of the prominent edge (10) of the second piece (6) in relation to the horizontal is 75°.
